(19) United States
(12) Patent Application Publication
(10) Pub. No.: US 2025/0358174 A1
(43) Pub. Date: Nov. 20, 2025

(54) VIRTUALIZING HARDWARE RESILIENCE FOR NETWORK CONNECTIONS

(71) Applicant: MELLANOX TECHNOLOGIES, LTD., Yokneam (IL)

(72) Inventors: Dimitrios Syrivelis, Volos (GR); Ioannis Patronas, Pireas (GR); Paraskevas Bakopoulos, Argiroupoli (GR); Avraham Ganor, Shoham (IL); Nikolaos Argyris, Zografou (GR); Nimr Hazin, Bani (IL); Dimitrios Kalavrouziotis, Papagos (GR); Elad Mentovich, Tel Aviv (IL)

(21) Appl. No.: 18/669,310

(22) Filed: May 20, 2024

(30) Foreign Application Priority Data
May 16, 2024 (GR) 20240100365

(51) Int. Cl. H04L 41/0663; H04L 41/0604

(52) U.S. Cl. CPC H04L 41/0663; H04L 41/0609

(57) ABSTRACT

A network resiliency controller may monitor a port status for a network interface controller. A software defined datapath may be used to virtualize different ports of the network interface controller and direct traffic to a given port. If it is determined that a port failure is imminent or has occurred, one or more selectors may modify a port associated with the network interface controller. The network resiliency controller may identify the port switching, determine a new connection has been established with a new port, and then modify one or more traffic rules for routing traffic along the new port.

### CROSS-REFERENCE TO RELATED APPLICATIONS

This application claims priority to Greek application No. 20240100365 filed May 16, 2024, and entitled “VIRTUALIZING HARDWARE RESILIENCE FOR NETWORK CONNECTIONS,” which is hereby incorporated herein in its entirety and for all purposes.

### BACKGROUND

Large data centers may connect various physical components using different wired and/or wireless communication protocols. For certain structures, fault tolerance may be low and/or substantially zero because a failure between different network links may cause crashes, leading to down time and lost productivity. In some cases, faults may occur at physical ports, such as ports of network switches and the like. When failures are detected, virtualized services may be migrated to different underlying hardware and then the network is reconfigured to direct traffic to the new location. However, with certain workloads, such as artificial intelligence (AI) workloads, fault tolerance may be lower, causing computationally costly restarts and reconfigurations.

### BRIEF DESCRIPTION OF THE DRAWINGS

Various embodiments in accordance with the present disclosure will be described with reference to the drawings, in which:

FIG. 1 illustrates a schematic diagram of a network model, in accordance with at least one embodiment;

FIG. 2 illustrates an example system for monitoring port status for a network communication component, in accordance with at least one embodiment;

FIG. 3A illustrates an example system for identifying and updating one or more network traffic rules, in accordance with at least one embodiment;

FIG. 3B illustrates an example system for identifying and updating one or more network traffic rules, in accordance with at least one embodiment;

FIG. 3C illustrates an example system for identifying and updating one or more network traffic rules, in accordance with at least one embodiment;

FIG. 3D illustrates an call diagram for monitoring a network connection and updating rules based on a connection status, in accordance with at least one embodiment;

FIG. 4A illustrates an example process for transmitting network traffic using one or more updated rules, in accordance with at least one embodiment;

FIG. 4B illustrates an example process for updating one or more network transmission rules, in accordance with at least one embodiment;

FIG. 4C illustrates an example process for generating updated network transmission rules, in accordance with at least one embodiment;

FIG. 5A illustrates an example process for transmitting network traffic using one or more updated rules, in accordance with at least one embodiment;

FIG. 5B illustrates an example process for transmitting network traffic using one or more updated rules, in accordance with at least one embodiment;

FIG. 5C illustrates an example process for updating one or more network transmission rules, in accordance with at least one embodiment;

FIG. 6 illustrates components of a distributed system that can be utilized to update or perform inferencing using a machine learning model, according to at least one embodiment;

FIG. 7 illustrates an example data center system, according to at least one embodiment;

FIG. 8 illustrates a computer system, according to at least one embodiment;

FIG. 9 illustrates a computer system, according to at least one embodiment;

FIG. 10 illustrates at least portions of a graphics processor, according to one or more embodiments; and

FIG. 11 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments are directed toward network connection resilience. In at least one embodiment, systems and methods may be associated with network interface controller (NIC) port resilience. Specifically, systems and methods are directed toward a software stack solution for dataplane control responsive to a determination that one or more ports of the NIC, or some other network connection component, have been switched over to other ports. A NIC may be associated with an switching device (e.g., an optical switching device) that makes up the physical connections of the NIC. If a port fails, the switching device can change the outlet port associated with the NIC to re-established the connection and verify that a new connection has been successfully formed. When it is determined that the new port has an established connection, one or more network forwarding rules associated with ingress and/or egress data traffic for the NIC may be evaluated to determine which rules identify the previous port and then update the rules to identify the new port. For example, a set of cloned rules may be activated while the previous rules associated with the old port are deactivated. As another example, one or more rules may be updated to replace the old port with the new port. In a further example, one or more rules may be assigned a different priority, such as a lower priority for the old port and a high priority for the new port. As a result, switching can be performed in less time that is below the link full reset trigger threshold, thereby accelerating the link bring up time between the new port pair. Systems and methods may be deployed using a monitor operating on one or more network resources or may execute based on firmware instructions using underlying hardware of the NIC.

Various systems and methods enable hardware resilience to mitigate NIC transceiver failures. At least one embodiment may be used with an N-port NIC (e.g., a NIC with at least two ports) having a capability at a physical layer to programmatically attach one of its ports to the network while using the other one as a reserve which can be immediately (e.g., without significant delay, with a delay less than a link breakup threshold, with a delay less than a link full reset trigger, etc.) attached if the first one fails. Certain embodiments may incorporate an optical port selector that is used to selectively interface one or the other transceiver of the NIC to an optical network. Accordingly, upon transceiver failure, the software stack design enables transparent migration of network connections from one port to the other which, given the timeout tolerance of a transport layer, allows the running job to continue with a minor glitch. Systems and methods may therefore overcome problems with existing failure mitigation techniques that often lead to computationally costly workload stoppages.

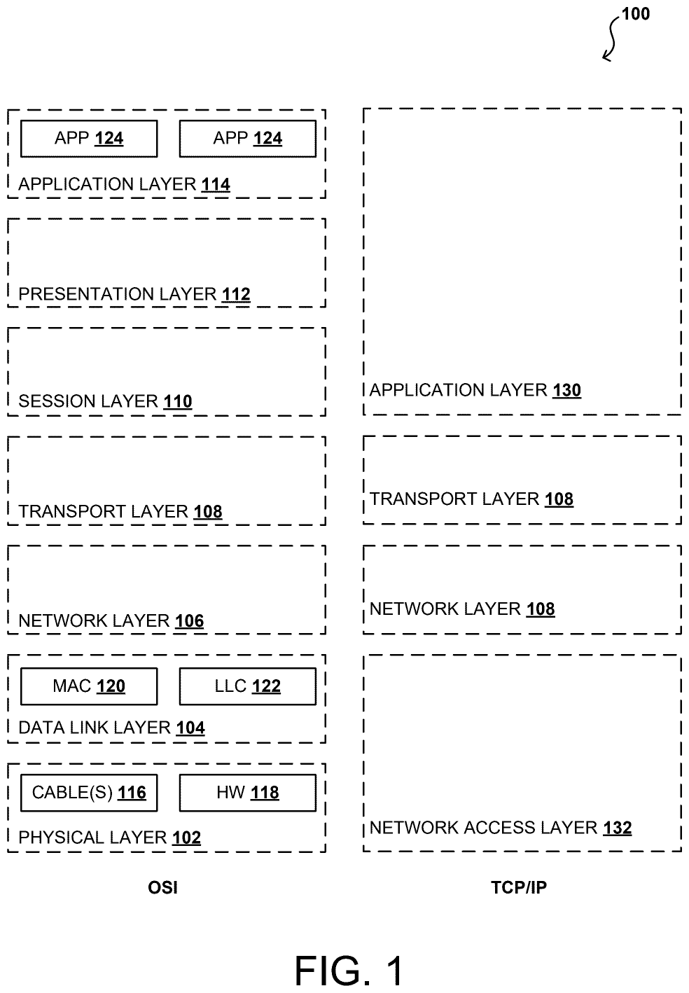

FIG. 1 illustrates a schematic diagram of a system 100 representing a simplified network model corresponding to the Open Systems Interconnection (OSI) model and the Transmission Control Protocol/Internet Protocol (TCP/IP) model. It should be appreciated that embodiments of the present disclosure may also be used with reference to either model and that specific discussion of a particular layer may be provided by way of non-limiting example and may include equivalents between the two models. Moreover, various features have been removed for clarity and conciseness. Additionally, systems and methods may be used with a variety of different architectures. Turning to the OSI model configuration, a physical layer 102 may refer to underlying hardware resources and signal transmission using one or more transmission media, such as cables. In operation, the physical layer 102 converts the binary from the upper layers, discussed herein, into signals and then transmits those signals over local media. The signals may be electrical, optical (e.g., light), radio, and/or the like. By way of example, the physical layer 102 may include systems associated with a data center, including features such as, but not limited to, data center rooms, racks, servers, processors (e.g., compute units), switches, cables, and/or the like. That is, the physical layer 102 may refer to physical connections between a network and the servers/other equipment. For example, the physical layer 102 may include cables 110 that are used to connect various hardware resources 118, such as servers and/or storage media to one or more network connections. Additionally, in at least one embodiment, the physical layer 102 may refer to different servers positioned within racks that are connected to one or more other servers using different wired or wireless communication protocols. The physical layer 102 may also include hardware resources such as switches or interface controllers, as discussed herein.

A data link layer 104 is used to receive information (e.g., packets) from a network layer 106. The data link layer 104 may be an embedded layer of one or more hardware units, such as the NIC. In operation, the data link layer 104 is used to directly connect different nodes, establish/terminate the connections, define the communication protocol between the modes. The data link layer 104 may include the medium access control (MAC) layer 120 and the logical link control (LLC) layer 122. The network layer 106 is used to transmit data segments from a source to a destination.

The illustrated model further includes a transport layer 108 that may be used to segment data for transmission along the network layer 106. The transport layer may use one or more protocols, such as user datagram protocol (UDP) or TCP for transmission of the data. A session layer 110 may be used to create connections, control connections, and then end sessions between two or more endpoints. In at least one embodiment, a presentation layer 112 may be used to receive data for transmission from an application layer 114 and may, in various embodiments, perform encryption or decryption of the data. The presentation layer 112 may be used to transform data, such as for protocol conversion, data encryption, data decryption, data compression, data decompression, incompatibility of data representation between operating systems, and graphic commands. An application layer 114 may represent one or more applications 124 that are closest to the end user. In at least one embodiment, the application layer 114 is associated with different operations that execute using the underlying resources, such as software programs the like that are loaded onto different virtual machines (VMs). As shown in this example, the application layer 130 for the TCP/IP model may include the application layer 114, the presentation layer 112, and the session layer 110 of the OSI model. Additionally, the TCP/IP model may also include a network access layer 132 that incorporates the data link layer 104 and the physical layer 102 of the OSI model.

Systems and methods of the present disclosure may be directed toward different configurations, such as data centers, where groups of servers may be represented as different clusters, among other options. The physical components within the data center may be communicatively coupled together using one or more network components, which may be associated with different ports. In operation, the ports receive packets of data for use by the connected components, such as the servers. “Dropping” a packet or otherwise not receiving information along a port may cause an executing job to fail or be delayed. As a result, the workload may be migrated to a different underlying hardware component, even if the failure is due to a transceiver. For certain workloads, failing a job may lead to restarting one or more operations from a checkpoint, which may be computationally costly and time consuming. Embodiments of the present disclosure address and overcome problems with existing systems by implementing hardware resistance using a software solution that enables a set of actions to activate different network flows to transparently switch between different ports associated with network components, such as a NIC. Systems and methods may be used to identify components and associated architectures using dataplane control solutions.

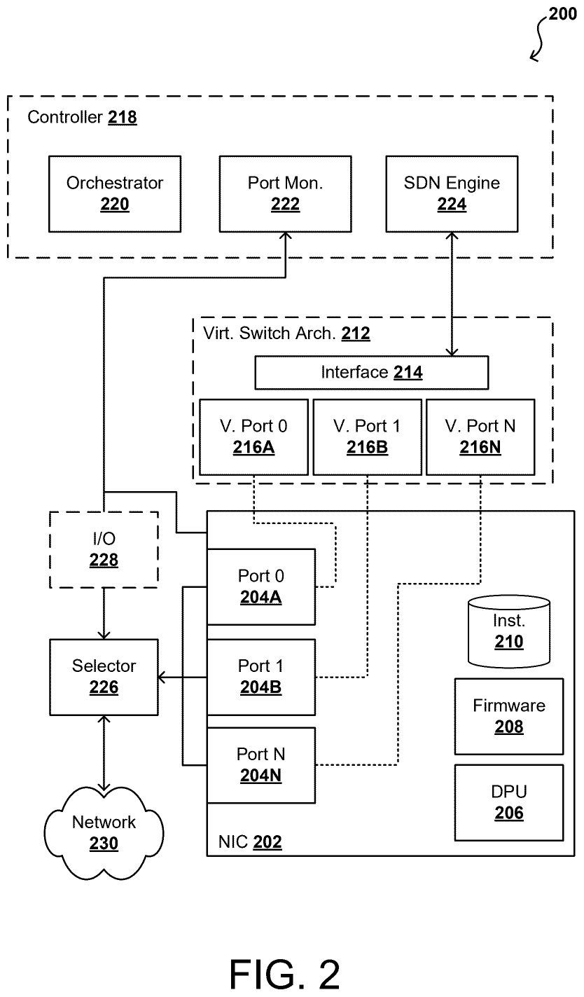

FIG. 2 illustrates an example system 200 schematically representing an architecture for a network component, which in this example is a NIC 202, and various connections to software and/or hardware resources. In operation, one or more features of the NIC 202 may be controlled or otherwise operated using a software datastack, which my include one or more virtualization architectures in order to virtually couple ports of the NIC 202 to one or more software-defined data paths. In this example, the NIC 202 is a multi-port NIC (e.g., an N port NIC 202) that includes at least two ports 204. The ports 204 of the illustrated example include Port 0 204A, Port 1 204B, and Port N 204N. Other embodiments may include more or fewer ports.

The illustrated NIC 202 may include onboard processing capabilities, for example a data processing unit (DPU) 206. The DPU 206 may execute one or more boot processes or commands from firmware 208 and/or different stored instructions within a data store 210, which may be onboard storage associated with the NIC 202. As will be discussed herein, systems and methods of the present disclosure may include a software stack that transparently directs traffic along one or more ports 204 based, at least in part, on a port state, among various other features. The software stack may run within a privileged environment associated with an orchestration infrastructure stack and/or can be a service associated with an isolated environment of the NIC 202 via the DPU 206. As a result, embodiments discussed herein may be deployed and controlled by an infrastructure provider.

In this example, a virtual switch architecture stack 212 may include an interface 214 and one or more virtual ports 216. The number of virtual ports 216 may correspond to the number of ports 204 associated with the NIC 202. In various embodiments, the number of virtual ports 216 may be dynamically adjustable based on the underlying NIC 202, and as a result, a variety of different NICs 202 may be used and certain NICs 202 may have different numbers of ports 204 supported by different virtual switch architecture stacks 212. For example, if the NIC 202 only included two ports 204, then the virtual switch architecture stack 212 may be configured with only two virtual ports 216. In this manner, the virtual switch architecture stack 212 may be adjusted and/or tuned to work with a variety of different NICs 202. In this example, the different virtual switches 216A-216N are mapped or otherwise associated with corresponding ports 204A-204N of the NIC 202. That is, the virtual port 0 216A is mapped to the port 0 204A, the virtual port 1 216B is mapped to the port 1 204B, and the virtual port N 216N is mapped to the port N 204N. The virtual ports 216 may be used to abstract the ports 204 of the NIC 202.

A controller 218 may be used to monitor port status, send instructions to switch ports, and/or to execute one or more different datapaths. In this example, the controller 218 includes an orchestrator, a port monitor 222, and a software defined networking engine (SDN) 224. The orchestrator 220 may assume the role of orchestrating the process of switching physical ports associated with the NIC 202. For example, the port monitor 222 may receive one or more signals indicative of a port status associated with a selector 226, which in this example may be an optical selector. In this example, an optional input/output (I/O) interface 228 may provide data to the port monitor 222. The port monitor 222 may determine which port 204A-204N is currently transmitting data via the selector 226 and, in certain embodiments, may monitor health of the port. For example, the port monitor 222 may provide indications regarding current port health, future port health, predicted port failures, and/or the like. It should be appreciated that the port monitor 222 may be omitted in various embodiments and port health and/or selector status may be monitored using on-board hardware associated with the NIC 202. For example, the firmware 208 may include monitoring capabilities to receive one or more signals from the ports 204 and/or the selector 226 to identify port status, selector position, and/or the like. Accordingly, while embodiments may discuss port monitoring with respect to the port monitor 222, alternatives may execute one or more of the same operations using the firmware 208. Additionally, certain features may use the port monitor 222 while other features use the firmware 208. For example, the port monitor 222 may execute one or more operations to offload tasks from the firmware 208 if it is determined that the tasks may exceed processing capabilities associated with the NIC 202.

In operation, the orchestrator 220 may receive a notification from the port state monitor 222 indicative of port health, such as an imminent port failure or current port failure. Imminent port failures may be predicted using one or more stored software evaluation methods, such as one or more trained machine learning models. For example, port failure may be determined based on sensor readings and/or data transmission information, such as a latency, an upload speed, a download speed, and/or the like. If a port is monitored over a period of time and latency is increasing by some threshold amount, the one or more models may determine that a failure is imminent. In at least one embodiment, rather than determining failure (e.g., unexpected or undesirable losses in connection), systems and methods may also monitor scheduled maintenance or switching operations, which may also be used to transmit signals to update software defined datapaths, as discussed herein.

The orchestrator 220, upon receiving a signal indicative of failure, imminent failure, pending maintenance, and/or the like, may then send a signal to the SDN engine 224 to stop negotiating new rules for the associated datapath. As a result, pack loss may be stopped while port switching occurs. The port monitor 222 and/or the orchestrator 220 may trigger the selector 226 to select a new port. In other embodiments, the selector 226 may automatically select a new port based on information received by the selector 226, such as a loss of an optical signal, an instruction from the NIC 202, and/or the like. New port selection may be based on one or more rules or may be random, among other options. The port monitor 222 may continue to monitor the port health until a new connection is verified as being complete and established. For example, it may be undesirable to execute different systems to modify networking traffic before identifying a new connection because if the new connection also fails, the process would need to be repeated. When the new connection is established, the orchestrator 220 may then signal the datapath to activate one or more alternative routing rules to activate the new ports and deactivate the old ports. Now, the datapath forward may resume operation. Various embodiments may execute the changeover of ports in less time than a transport layer timeout limit, and as a result, the workload associated with the port may not need to be restarted. As discussed herein, one or more tasks of the port monitor 222 may be offloaded to or controlled by the NIC 202 and its underlying hardware, such as the DPU 206 executing instructions from the firmware 208 and/or the instruction datastore 210. For example, monitoring of existing or new connections may be performed by the NIC 202 and then signals may be transmitted to the orchestrator 220 to initiate the datapath updates.

In this example, the interface 214 may be a representor interface to a host. It should be appreciated that while various terminology used herein may refer to Ethernet and IP protocols, systems and methods may be used with any L2 interface technology that can be integrated with a software defined network datapath. In operation, the ports 204 and/or virtual ports 216 are configured in promiscuous mode and act as passthrough ports for the ethernet frames without changing MAC addresses. The interface 214 may be configured to control MAC address and the address resolution protocol (ARP) to advertise itself to a network 230 regardless if the traffic is bridged through the port 0 204A or the port 1 204B, among other potentially available ports.

In at least one embodiment, a software defined datapath, for example one associated with the virtual switch architecture 212, may be modified so that one or more rules that designate the interface 214 are cloned to redirect traffic to a different port 204A-204N. For example, the datapath may store multiple versions of a rule, one defining a first port, one defining a second port, etc. Alternatively, the datapath may mark or otherwise tag port references within different rules so that, upon determining a port has been swapped, the ports within different rules can be easily identified and modified to redirect traffic. In at least one embodiment, a variety of rules may be stored for different ports and then assigned a priority value based on the selected port for network traffic. In the example for storing multiple rules, a first rule associated with the port 0 204A may be cloned so that references to the port 0 204A are replaced with references to the port 1 204B. In operation, one of the rules may be deactivated and/or activated to route traffic appropriately. In at least one embodiment, the rules may be shared or otherwise accessible with the SDN engine 224 to facilitate restoration in case of failure or reset.

Various embodiments may leverage features of the NIC 202. For example, the firmware 208 may provide support for detecting a state of an active port. NIC-supported monitoring may be used separately or in combination with the port monitor 222. For example, the port monitor 222 may also communicate with the NIC 202 to obtain information collected by the NIC 202. For example, port state changes notifications may be provided via polling or callback.

As discussed herein, the controller 218 may also be referred to as a high availability controller that functions as a resilience orchestrator to control the process of switching physical ports. In certain embodiments, the controller 218, and/or components thereof, receives notifications from a port state monitor (e.g., the port state monitor 222, components of the NIC 202, etc.) that a port failure is imminent or has already happened. The controller 218 may then quiesce the SDN engine 224 to stop negotiating new rules with the datapath to stop loosing packets. Then, the port monitor 222 may trigger the selector 226 to interface the network 230 to a reserve port. Subsequently, the port monitor 222 or equivalent NIC component may poll to identify that the new port link bringup is completed. As discussed herein, executing further operations without verifying the new port link may use unnecessary compute resources. Upon completion signaling from the port monitor 222 and/or equivalent NIC component, the orchestrator 220 may signal the datapath to activate the cloned flows for the newly activated port and deactivate the old ones or re-assign priorities to the existing rules accordingly so the rules towards the new port are firstly matched. Alternatively, the orchestrator 220 may signal the datapath to update or modify one or more rules based on an identification of the new port. As another option, in certain embodiments the orchestrator 220 may change one or more priorities for the one or more rules for directing network traffic. Accordingly, systems and methods may be used to redirect traffic flow using a virtualized port service and then link the traffic through a selected port of the underlying NIC 202.

Various embodiments, of the present disclosure may be directed toward systems and methods to update one or more rules to control traffic for a datapath. In at least one embodiment, the traffic may be controlled by a software stack that determines a network connection associated with a first port is moved to a second port based on a position of an optical port selector. For example, the port selector 226 may move from the port 0 204A to the port 1 204B. One or more rules associated with the datapath may also be identified. These rule may be stored locally on the NIC 202 and/or may be stored as part of the controller 218 and/or the virtual switch architecture stack 212. The one or more rules may be identified based on one or more identifiers or instructions associated with the first port, such as the port 0 204A. The one or more rules may then be updated to direct traffic to the second port. Updating the rules may include changing values within the rules to be associated with second port, such as the port 1 204B. The one or more rules may also be updated to deactivate the rules associated with the first port and to activate one or more rules associated with the second port. As a result, the updated one or more rules may be used to control subsequent traffic to the NIC 202.

Systems and methods may further be directed toward a network system including at least the NIC 202, the selector 226, and the controller 218. The controller may execute one or more software instructions to determine whether the selector 226 has changed from receiving data from a first port to a second port. In at least one embodiment, the selector 226 is a physical component associated with the NIC 202 and a position of the selector 226 may be indicative of the associated port for receiving data. For example, the selector 226 may open or close an optical pathway for data communication, change alignment between different optical pathways, and./or the like. In at least one embodiment, responsive to a determination of a port failure, such as by the firmware 208, the selector 226 may stop receiving a signal from the port 0 204A and start receiving a signal from the port 1 204B. Once it is determined that a new connection using the port 1 204B is established, one or more rules for routing traffic associated with the NIC 202 may be updated. For example, one or more rules that reference the first port (e.g., the port 0 204A) may be updated to reference the second port (e.g., the port 1 204B).

In at least one embodiment, one or more processes or methods may be implemented in order to determine a network connection associated with a second port is established after switching from a first port. For example, after the optical selector 226 switches from a first port to a second port, a network connection associated with the second port may be verified prior to proceeding with updating network traffic rules. One or more identifiers associated with the first port may be located within a software defined datapath and may be updated to reference the second port. As a result, traffic being received at the associated NIC 202 may then be routed according to the updated software defined datapath to use the second port.

Various embodiments may also include one or more methods to determine a network connection to a target port is established. The one or more methods may also include identifying, within a software defined datapath, one or more rules associated with a prior port. For example, the target port may be a second port after an optical selector has been switched and the prior port may be the port that was switched away from. In at least one embodiment, one or more updated rules for the software defined datapath may be generated. The updated one or more rules may replace the prior port with the target port within the one or more rules. Thereafter, transmission along the network connection may be performed according to the one or more updated rules.

Systems and methods may further be directed toward a NIC having two or more ports and a controller, such as the NIC 202 and the controller 218. The controller 218, or components thereof, may be used to determine a first status of a first port of the two or more ports has a threshold value. For example, the port monitor 222 may determine that a value associated with the first port is indicative of a failure or an imminent failure, among other options. Thereafter, the controller 218 may be used to establish a connection to a network using a second port of the two or more ports. For example, a signal may be transmitted to the optical selector 226 to use the second port. Upon verifying the new connection, one or more rules for traffic associated with the NIC 202 may be updated to use the second port.

In at least one embodiment, one or more software defined datapaths may be used to determine a change in a port state for a network connection. Based on the change, one or more rules associated with the datapath may be updated. Thereafter, data may be transmitted based on the updated one or more rules.

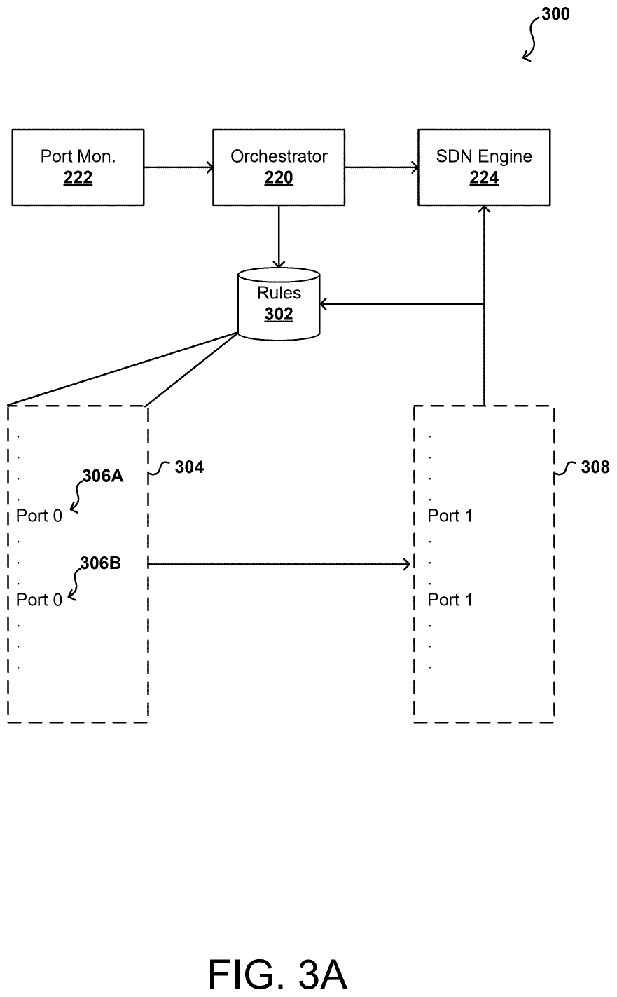

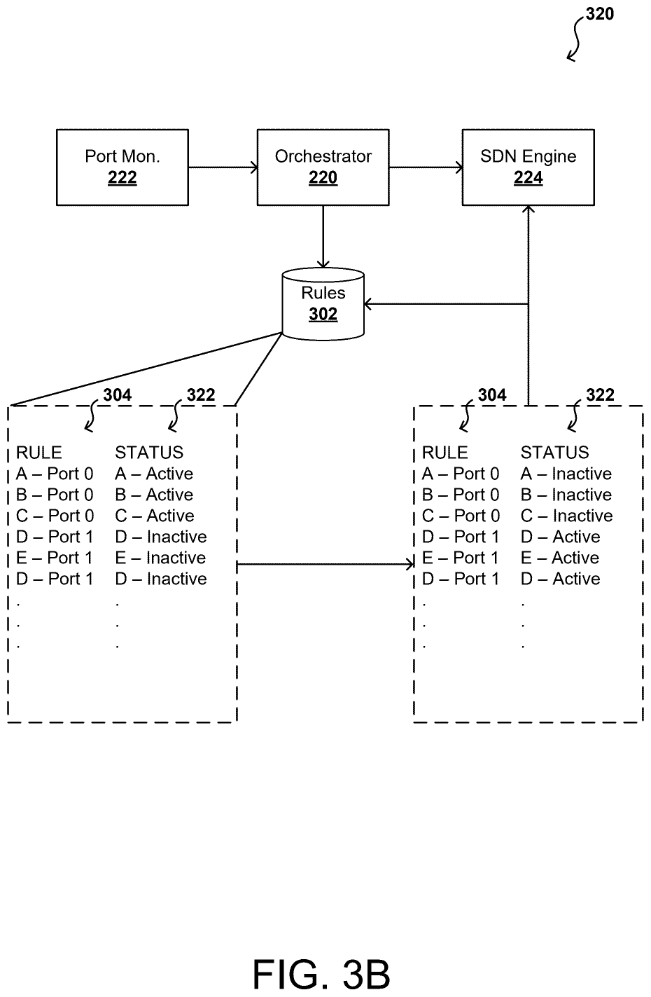

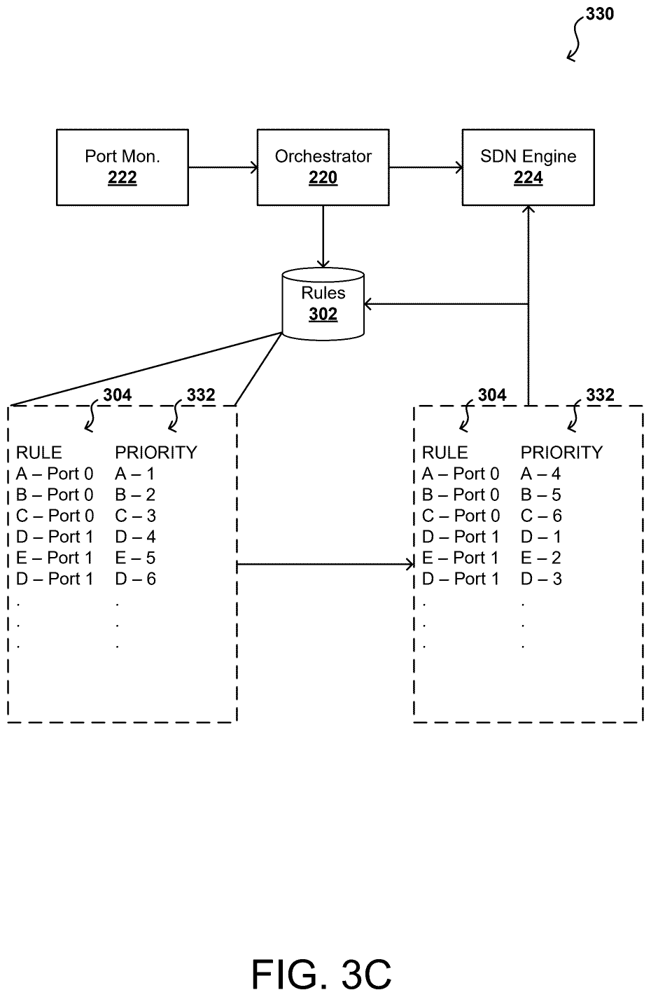

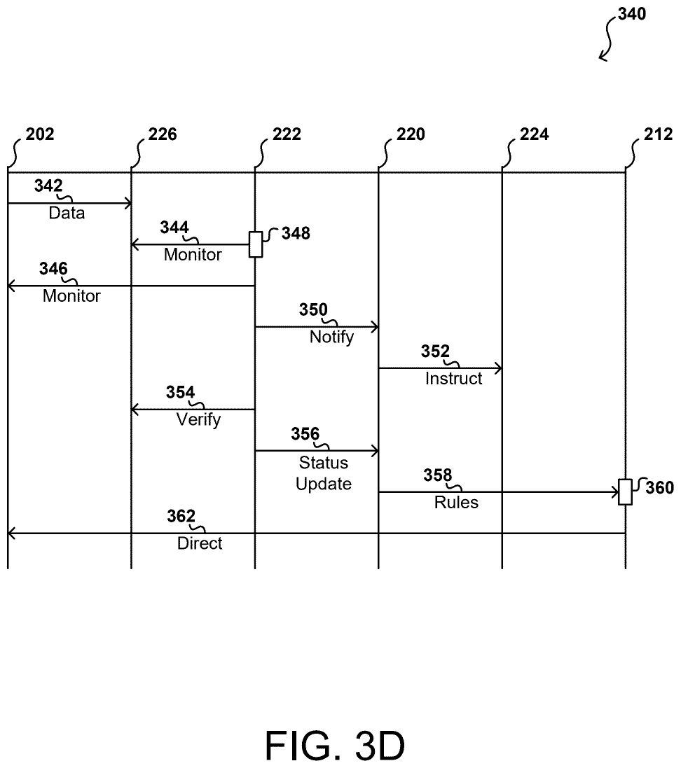

FIG. 3A illustrates an example environment 300 that may be used to update one or more traffic routing rules, in accordance with embodiments of the present disclosure. In this example, the port monitor 222 may provide one or more signals or indicators to the orchestrator 220 regarding a port state for a given NIC. The inclusion of the port monitor 222 is provided as an example, as discussed herein, and in one or more embodiments the NIC 202 may also provide information to the orchestrator 220 and/or alternatively provide information to the orchestrator 220. For example, the signals may provide information related to an imminent or current port failure. As a result of the port failure, the orchestrator 220 may provide a signal to the SDN engine 224 to halt traffic until the port failure is remedied. For example, the port monitor 222 may provide a second signal indicative of a newly established connection using a new port. The orchestrator 220 may then initiate one or more workflows to update or modify one or more traffic routing rules.

The one or more traffic routing rules may be stored in a rules datastore 302, which may be accessible by the orchestrator 220. In this example, a rule 304 corresponds to instructions for routing traffic and may include references 306 to one or more ports. For example, the rule 304 includes references 306A, 306B to the port 0. If the port 0 were associated with the initial failure signal from the port monitor 222, then systems and methods of the present disclosure may be used to update or otherwise modify the rule 304 to replace references to the port 0 with a newly established connection using a different port.

In this example, a new or updated rule 308 is generated where references to the port 0 are replaced by the port 1. The new rule 308 may then be provided back to the rules datastore 302 and/or to the SDN engine 224 to restart traffic flow in accordance with the parameter set forth in the new rule 308. Various embodiments may enable updates and modifications to the rule 304 in less time than a link breakup threshold (e.g., less than a full reset trigger), and as a result, the associated workflows with the link may not need to be restarted.

FIG. 3B illustrates an example environment 320 that may be used to change a rule status for one or more traffic routing rules, in accordance with embodiments of the present disclosure. In this example, the port monitor 222 may be used to inform the orchestrator 220 of one or more imminent and/or current port failures, as well as a status of a newly selected and established port, as discussed herein. Similarly to FIG. 3A, the port monitor 222 may be replaced and/or supplemented by the NIC 202. As a result of the port failure, the orchestrator 220 may provide a signal to the SDN engine 224 to halt traffic until the port failure is remedied and then the orchestrator 220 may then initiate one or more workflows to update or modify one or more traffic routing rules.

As shown in FIG. 3A, one or more traffic routing rules may be stored in the rules datastore 302, which may be accessible by the orchestrator 220. In this example, the set of rules 304 may be included with the rules datastore 302 with associated status identifiers 322. The status identifiers 322 may correspond to a current state of the rule, such as whether the rule is being executed. The status identifiers 322 may be tunable parameters that enable different rules to be activated or deactivated responsive to different traffic flows, settings, and/or the like. In at least one embodiment, rules may be associated with a given port and may be duplicated or cloned to be associated with other potential ports for a given NIC. For example, in the illustrated embodiment, the rule A may correspond to the rule D, but for the port 0 being associated with rule A and the port 1 being associated with rule D. However, in other embodiments, the rules may note be the same and/or may include other differences.

Responsive to the determination of the port failure and newly a established connection for a different port, the status identifiers 322 for the respective rules 304 associated with the port 0 may be switched from “active” to “inactive” while the rules 304 associated with the port 1 may be switched from “inactive” to “active.” As a result, systems and methods may rapidly modify traffic routing rules responsive to port states.

FIG. 3C illustrates an example environment 330 that may be used to change a rule status for one or more traffic routing rules, in accordance with embodiments of the present disclosure. In this example, the port monitor 222 may be used to inform the orchestrator 220 of one or more imminent and/or current port failures, as well as a status of a newly selected and established port, as discussed herein. Similarly to FIGS. 3A and 3B, the port monitor 222 may be replaced and/or supplemented by the NIC 202. As a result of the port failure, the orchestrator 220 may provide a signal to the SDN engine 224 to halt traffic until the port failure is remedied and then the orchestrator 220 may then initiate one or more workflows to update or modify one or more traffic routing rules.

As shown in FIGS. 3A and 3B, one or more traffic routing rules may be stored in the rules datastore 302, which may be accessible by the orchestrator 220. In this example, the set of rules 304 may be included with the rules datastore 302 with priority designations 332. The priority designations 332 may correspond to an order in which the rules are applied and/or a ranking of rules to apply. In at least one embodiment, rules having a threshold value may not be executed. The illustrated values are shown by way of non-limiting example. For example, rather than each rule 304 having a different priority value, all rules that are set to execute may have a first value and all other rules may have a second value. In at least one embodiment, rules may be associated with a given port and may be duplicated or cloned to be associated with other potential ports for a given NIC, as discussed herein. However, in other embodiments, the rules may not be the same and/or may include other differences.

Responsive to the determination of the port failure and newly established port, the priority designations 332 for the respective rules 304 associated with the port 0 may be switched from values associated with active execution (values 1-3 in this example) to values associated with inactive execution (values 4-6 in this example) while the rules 304 associated with the port 1 may be switched from values associated with inactive execution to values associated with active execution. As a result, systems and methods may rapidly modify traffic routing rules responsive to port states.

FIG. 3D illustrates an example call diagram 340 that may be used with embodiments of the present disclosure. As discussed herein, one or more calls or commands may be transmitted from one or more alternative sources. For example, the port monitor 222 may be replaced and/or supplemented by the NIC 202, among various other options. In this example, the NIC 202 provides a data signal 342 to the port selector 226. The data signal may be an optical signal that is transmitted to the port selector 226, which may be an optical selector, that aligns the one or more ports of the NIC 202. In at least one embodiment, the port monitor 222 may monitor a selector position 344 to determine which port of the NIC 202 is transmitting the data. For example, a selector position may be indicative of a certain port. Alternatively, or additionally, the port monitor 222 may also monitor the port of the NIC 202 346 to evaluate a port health, such as determining an imminent or existing failure.

In at least one embodiment, it may be determined, by the port monitor 222, that a failure is imminent and/or pending 348. For example, one or more signals may associated with the monitoring 344, 346 indicative of failure, such as latency or a loss of data transmission, among other options. As a result, the port monitor 222 may notify 350 the orchestrator 220, which may subsequently instruct 352 the SDN engine 224 to halt further traffic.

In at least one embodiment, the selector 226 may switch positions associated with the NIC 202 to establish a new connection, for example using a new port, and the port monitor 222 may verify 354 a successful connection has been formed. Upon verification of the new connection, the port monitor 222 may update 356 the port status to the orchestrator 220, which may then implement 358 one or more workflows to update one or more rules associated with the network traffic. For example, the virtual switch architecture 212 may update various routing rules 360 and/or receive updated routing rules and then direct 362 traffic using the NIC 202 according to the updated rules.

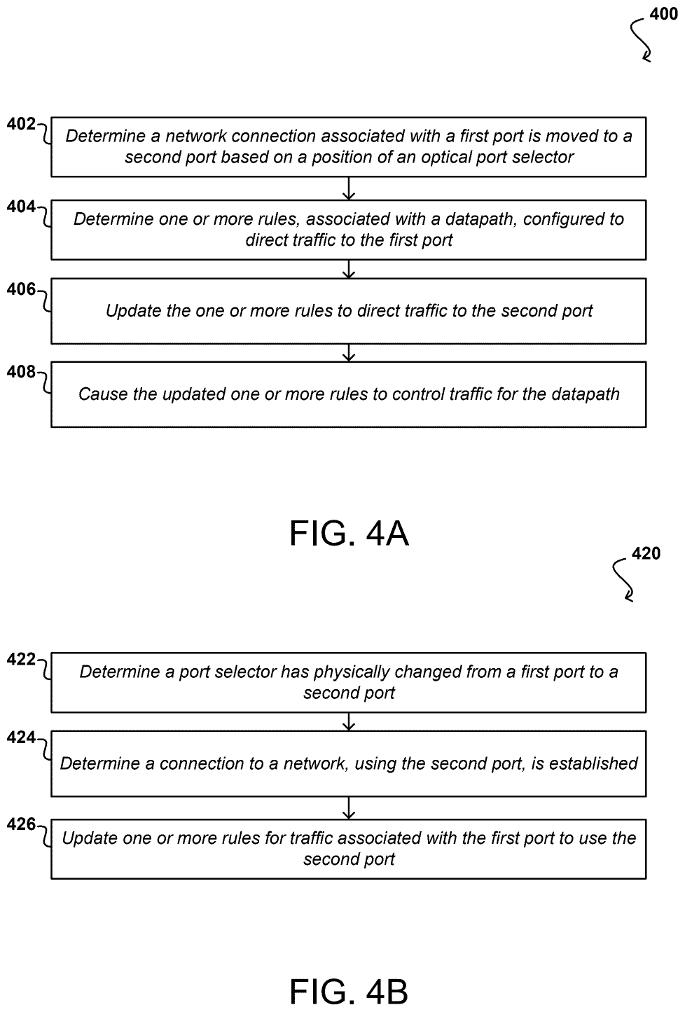

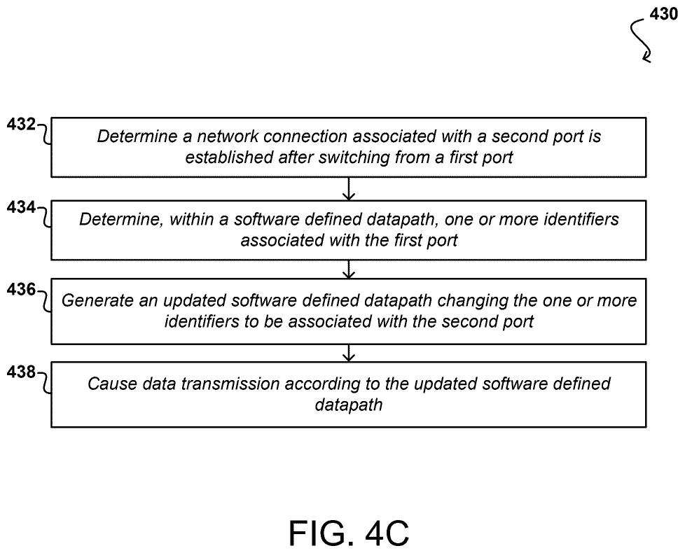

FIG. 4A illustrates an example process 400 that can be used to update one or more rules to control traffic for a datapath. It should be understood that for this and other processes presented herein that there may be additional, fewer, or alternative operations performed in similar or alternative orders, or at least partially in parallel, within the scope of the various embodiments unless otherwise specifically stated. In this example, it may be determined that a network connection associated with a first port is moved to a second port 402. The movement of the connection may be based on a signal received from one or more port selectors, such as an optical port selector. In at least one embodiment, one or more interfaces may be used to obtain selector position information. The position information may be obtained using one or more port monitors and/or using hardware associated with the NIC. In at least one embodiment, one or more rules may be determined for directing traffic associated with the NIC. For example, the rules may be associated with a virtualized datapath and may include one or more references to the first port (e.g., the port that was switched away from). The rules may be identified based on various markers or references, among other options.

In at least one embodiment, the one or more rules associated with the first port are updated to redirect traffic to the second port 406. For example, the rules may be changed to remove references to the first port and replace references to the first port with the second port. In another example, the one or more rules associated with the first port may be deactivated while one or more rules associated with the second port are activated. Additionally, in at least one embodiment, one or more rules associated with the first port may have a priority value changed to be lower priority than one or more rules associated with the second port. The updated one or more rules may then be used to direct traffic for the datapath 408. Accordingly, systems and methods may implement rapid changes to traffic control rules based on an indication associated with a port failure or imminent failure.

FIG. 4B illustrates an example process 420 for updating traffic routing rules. In this example, it may be determined that a port selector has physically changed from a first port to a second port 422. For example, the port selector may be an optical port selector and a signal may be transmitted responsive to movement between aligning optical ports. It may then be determined that a new network connector, using the second port, is established 424. For example, the second connection may include one or more handshake or otherwise connection steps that may be verified to ensure a connection is formed before updating any other routing rules. One or more rules may then be updated to redirect traffic from the first port to the second port 426. The updated rules may include modifications to the rules, changing rule priorities, activating or deactivating rules, and/or combinations thereof.

FIG. 4C illustrates an example process 430 to causing network traffic to flow using a software defined datapath. In this example, it may be determined that a network connection associated with a second port is established after switching from a first port 432. The switching may be the result of an imminent or recent port failure, among other options. One or more software defined datapaths may then be evaluated to determine locations for one or more identifiers associated with the first port 434. For example, certain references to the first port may be associated with identifiers or other features to quickly recognize port locations within the datapath. An updated software defined datapath may then be generated 436. For example, the updated software defined datapath may replace references to the first port with references to the second port. Thereafter, data transmission may be routed using the updated software defined datapath 438.

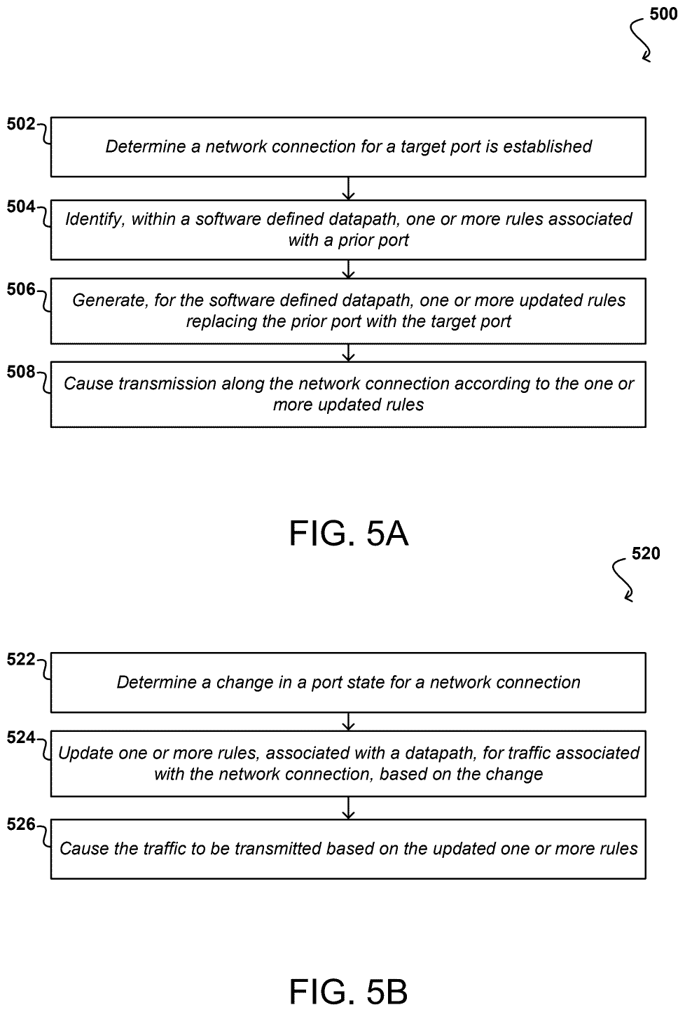

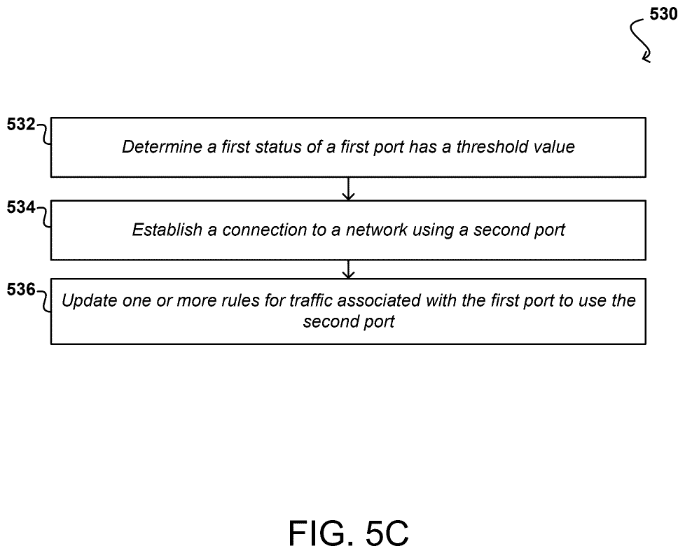

FIG. 5A illustrates an example process 500 for transmitting network traffic according to one or more rules. In this example, a network connection for a target port is established 502. The target port may be a new port that is selected after a previous port failure. A software defined datapath may then be evaluated to identify one or more rules associated with a prior port 504, which may include the port that was switched away from. One or more updated rules may then be generated to replace the prior port, within the rules, with the target port 506. Thereafter, transmission along the network connection may be routed using the one or more updated rules 508.

FIG. 5B illustrates an example process 520 for transmitting network traffic according to one or more rules. In this example, it may be determined that port state has changed for a network connection 522. For example, the port state may be changed to indicate a failure or an impending failure, among other options. One or more rules associated with a datapath may then be updated based on the changed port state. 524 For example, rule may be deactivated if it was determined that the port state was a failure. As another example, rule may be activated if it was determined that the port state was indicative of a new network connection. The traffic may then be routed using the updated one or more rules 526.

FIG. 5C illustrates an example process 530 for updating one or more rules for network traffic. In this example, a first status for a first port is determined to have a threshold value 532. In at least one embodiment, the threshold value may be indicative of a failure or imminent failure, among other options. A connection to the network using a second port may then be established 534. For example, a port selector may use a different port for an associated NIC. One or more traffic rules may then be updated for traffic associated with the first port to redirect traffic to the second port 536. In this manner, physical connection changes can be identified and updated.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

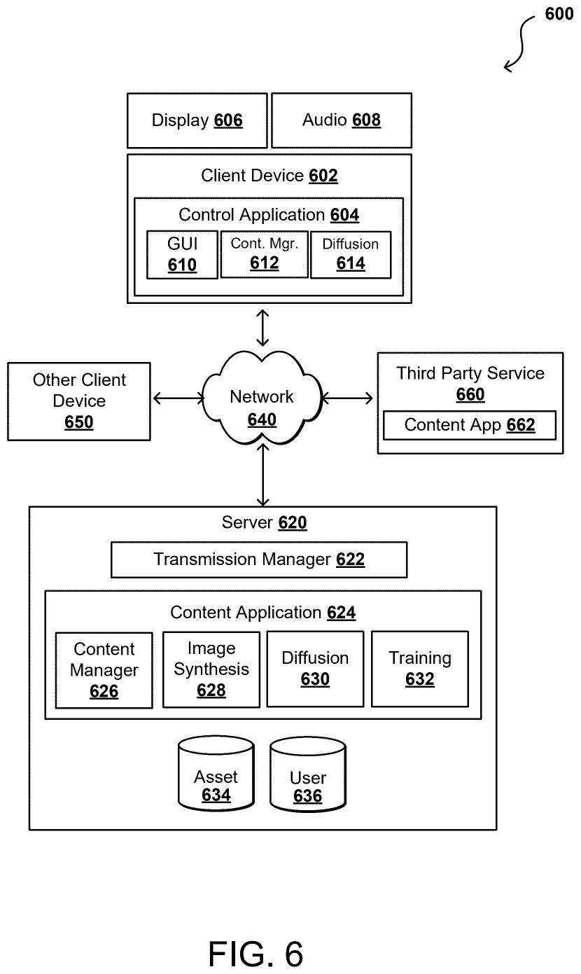

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an image synthesis module 628 to generate or synthesize new objects, digital assets, or other such content to be provided for presentation via the client device 602. In at least one embodiment, this image synthesis module 628 can use one or more neural networks, or machine learning models, which can be trained or updated using a training module 632 or system that is on, or in communication with, the server 620. This can include training and/or using a diffusion model 630 to generate content tiles that can be used by an image synthesis module 628, for example, to apply a non-repeating texture to a region of an environment for which image or video data is to be presented via a client device 602. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and image synthesis or diffusion module 614 for use in providing, synthesizing, modifying, or using content for presentation (or other purposes) on or by the client device 602. A decoder may also be used to decode data received over the network 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Data Center

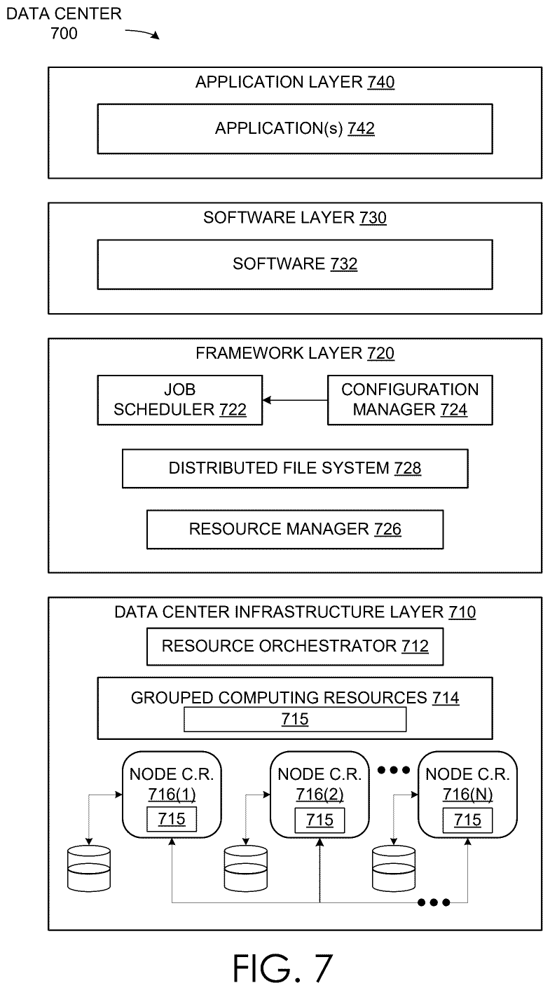

FIG. 7 illustrates an example data center 700, in which at least one embodiment may be used. In at least one embodiment, data center 700 includes a data center infrastructure layer 710, a framework layer 720, a software layer 730, and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 712 may configure or otherwise control one or more node C.R.s 716(1)-716(N) and/or grouped computing resources 714. In at least one embodiment, resource orchestrator 712 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 722, a configuration manager 724, a resource manager 726 and a distributed file system 728. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may use distributed file system 728 for large-scale data processing (e.g., “big data”). In at least one embodiment, job scheduler 722 may include a Spark driver to facilitate scheduling of workloads supported by various layers of data center 700. In at least one embodiment, configuration manager 724 may be capable of configuring different layers such as software layer 730 and framework layer 720 including Spark and distributed file system 728 for supporting large-scale data processing. In at least one embodiment, resource manager 726 may be capable of managing clustered or grouped computing resources mapped to or allocated for support of distributed file system 728 and job scheduler 722. In at least one embodiment, clustered or grouped computing resources may include grouped computing resource 814 at data center infrastructure layer 710. In at least one embodiment, resource manager 726 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 728 of framework layer 720. The one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 728 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 724, resource manager 726, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underused and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 7 for inferencing or predicting operations based, at least in part, on weight parameters calculated using neural network training operations, neural network functions and/or architectures, or neural network use cases described herein. Such components can be used for network traffic monitoring and control.

### Computer Systems

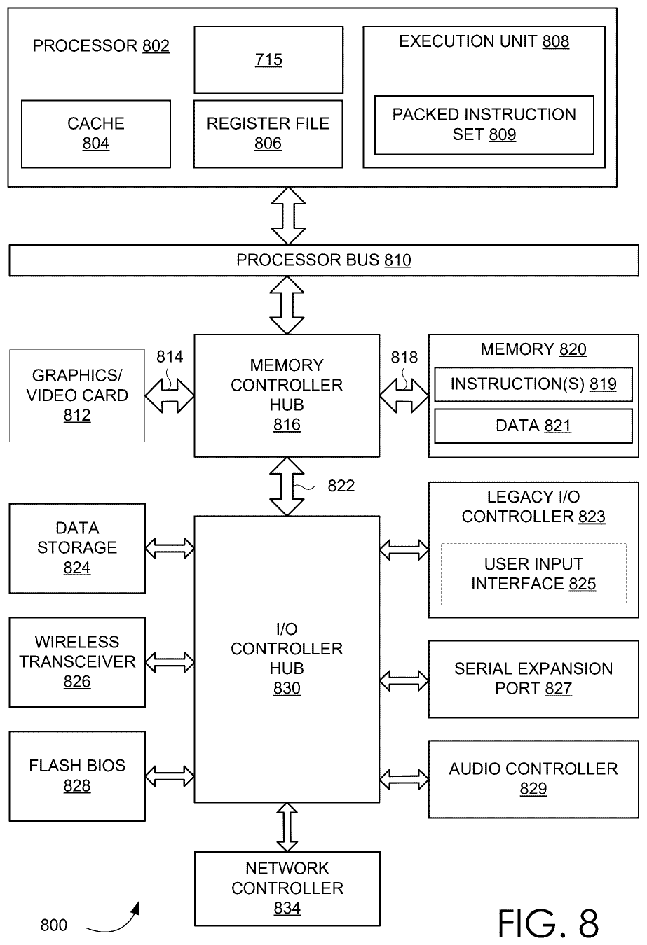

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interface(s) 825, a serial expansion port 827, such as Universal Serial Bus (“USB”), and a network controller 834. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 715 are used to perform inferencing and/or training operations associated with one or more embodiments. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for network traffic monitoring and control.

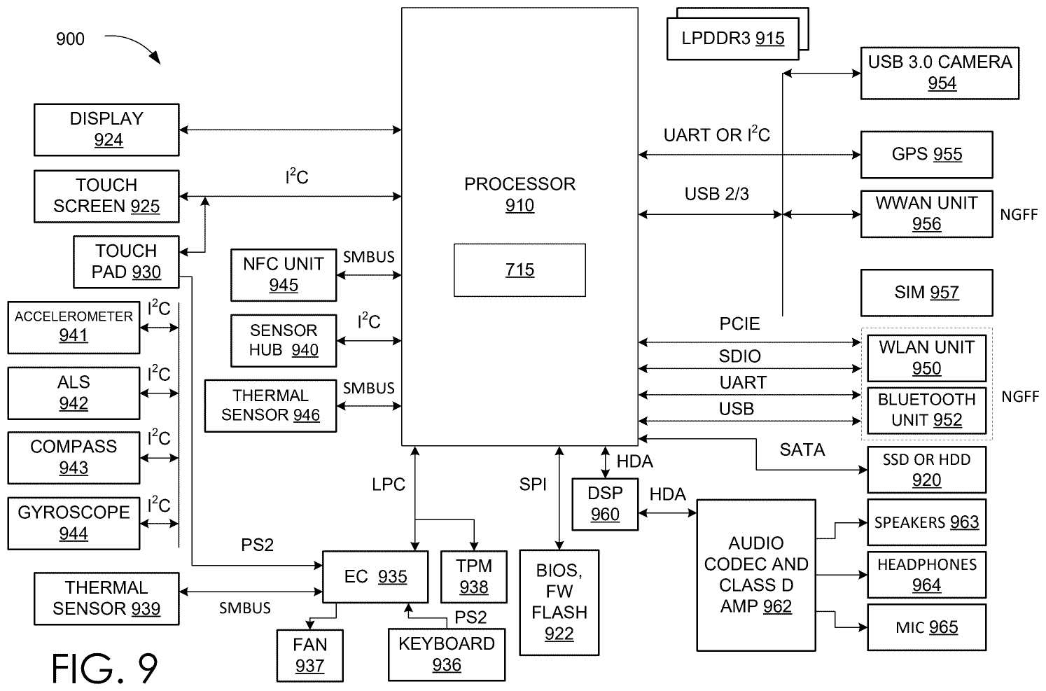

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 900 may include, without limitation, processor 910 communicatively coupled to any suitable number or kind of components, peripherals, modules, or devices. In at least one embodiment, processor 910 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speakers 963, headphones 964, and microphone (“mic”) 965 may be communicatively coupled to an audio unit (“audio codec and class d amp”) 962, which may in turn be communicatively coupled to DSP 960. In at least one embodiment, audio unit 964 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for network traffic monitoring and control.

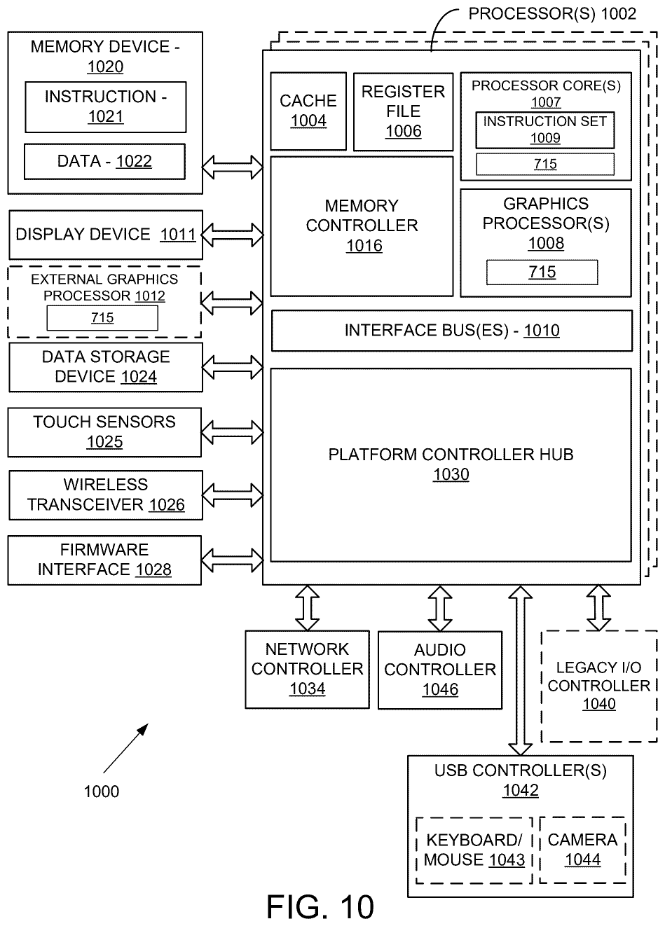

FIG. 10 is a block diagram of a processing system, according to at least one embodiment. In at least one embodiment, system 1000 includes one or more processor(s) 1002 and one or more graphics processor(s) 1008, and may be a single processor desktop system, a multiprocessor workstation system, or a server system having a large number of processor(s) 1002 or processor core(s) 1007. In at least one embodiment, system 1000 is a processing platform incorporated within a system-on-a-chip (SoC) integrated circuit for use in mobile, handheld, or embedded devices.

In at least one embodiment, system 1000 can include, or be incorporated within a server-based gaming platform, a game console, including a game and media console, a mobile gaming console, a handheld game console, or an online game console. In at least one embodiment, system 1000 is a mobile phone, smart phone, tablet computing device or mobile Internet device. In at least one embodiment, processing system 1000 can also include, couple with, or be integrated within a wearable device, such as a smart watch wearable device, smart eyewear device, augmented reality device, or virtual reality device. In at least one embodiment, processing system 1000 is a television or set top box device having one or more processor(s) 1002 and a graphical interface generated by one or more graphics processor(s) 1008.

In at least one embodiment, one or more processor(s) 1002 each include one or more processor core(s) 1007 to process instructions which, when executed, perform operations for system and user software. In at least one embodiment, each of one or more processor core(s) 1007 is configured to process a specific instruction set 1009. In at least one embodiment, instruction set 1009 may facilitate Complex Instruction Set Computing (CISC), Reduced Instruction Set Computing (RISC), or computing via a Very Long Instruction Word (VLIW). In at least one embodiment, processor core(s) 1007 may each process a different instruction set 1009, which may include instructions to facilitate emulation of other instruction sets. In at least one embodiment, processor core(s) 1007 may also include other processing devices, such a Digital Signal Processor (DSP).

In at least one embodiment, processor(s) 1002 includes cache memory 1004. In at least one embodiment, processor(s) 1002 can have a single internal cache or multiple levels of internal cache. In at least one embodiment, cache memory is shared among various components of processor(s) 1002. In at least one embodiment, processor(s) 1002 also uses an external cache (e.g., a Level-3 (L3) cache or Last Level Cache (LLC)) (not shown), which may be shared among processor core(s) 1007 using known cache coherency techniques. In at least one embodiment, register file 1006 is additionally included in processor(s) 1002 which may include different types of registers for storing different types of data (e.g., integer registers, floating point registers, status registers, and an instruction pointer register). In at least one embodiment, register file 1006 may include general-purpose registers or other registers.

In at least one embodiment, one or more processor(s) 1002 are coupled with one or more interface bus(es) 1010 to transmit communication signals such as address, data, or control signals between processor(s) 1002 and other components in system 1000. In at least one embodiment, interface bus(es) 1010, in one embodiment, can be a processor bus, such as a version of a Direct Media Interface (DMI) bus. In at least one embodiment, interface bus(es) 1010 is not limited to a DMI bus, and may include one or more Peripheral Component Interconnect buses (e.g., PCI, PCI Express), memory busses, or other types of interface busses. In at least one embodiment processor(s) 1002 include an integrated memory controller 1016 and a platform controller hub 1030. In at least one embodiment, memory controller 1016 facilitates communication between a memory device and other components of system 1000, while platform controller hub (PCH) 1030 provides connections to I/O devices via a local I/O bus.

In at least one embodiment, memory device 1020 can be a dynamic random access memory (DRAM) device, a static random access memory (SRAM) device, flash memory device, phase-change memory device, or some other memory device having suitable performance to serve as process memory. In at least one embodiment memory device 1020 can operate as system memory for system 1000, to store data 1022 and instruction 1021 for use when one or more processor(s) 1002 executes an application or process. In at least one embodiment, memory controller 1016 also couples with an optional external graphics processor 1012, which may communicate with one or more graphics processor(s) 1008 in processor(s) 1002 to perform graphics and media operations. In at least one embodiment, a display device 1011 can connect to processor(s) 1002. In at least one embodiment display device 1011 can include one or more of an internal display device, as in a mobile electronic device or a laptop device or an external display device attached via a display interface (e.g., DisplayPort, etc.). In at least one embodiment, display device 1011 can include a head mounted display (HMD) such as a stereoscopic display device for use in virtual reality (VR) applications or augmented reality (AR) applications.

In at least one embodiment, platform controller hub 1030 enables peripherals to connect to memory device 1020 and processor(s) 1002 via a high-speed I/O bus. In at least one embodiment, I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). In at least one embodiment, data storage device 1024 can connect via a storage interface (e.g., SATA) or via a peripheral bus, such as a Peripheral Component Interconnect bus (e.g., PCI, PCI Express). In at least one embodiment, touch sensors 1025 can include touch screen sensors, pressure sensors, or fingerprint sensors. In at least one embodiment, wireless transceiver 1026 can be a Wi-Fi transceiver, a Bluetooth transceiver, or a mobile network transceiver such as a 3G, 4G, or Long Term Evolution (LTE) transceiver. In at least one embodiment, firmware interface 1028 enables communication with system firmware, and can be, for example, a unified extensible firmware interface (UEFI). In at least one embodiment, network controller 1034 can enable a network connection to a wired network. In at least one embodiment, a high-performance network controller (not shown) couples with interface bus(es) 1010. In at least one embodiment, audio controller 1046 is a multi-channel high definition audio controller. In at least one embodiment, system 1000 includes an optional legacy I/O controller 1040 for coupling legacy (e.g., Personal System 2 (PS/2)) devices to system. In at least one embodiment, platform controller hub 1030 can also connect to one or more Universal Serial Bus (USB) controller(s) 1042 connect input devices, such as keyboard and mouse 1043 combinations, a camera 1044, or other USB input devices.

In at least one embodiment, an instance of memory controller 1016 and platform controller hub 1030 may be integrated into a discreet external graphics processor, such as external graphics processor 1012. In at least one embodiment, platform controller hub 1030 and/or memory controller 1016 may be external to one or more processor(s) 1002. For example, in at least one embodiment, system 1000 can include an external memory controller 1016 and platform controller hub 1030, which may be configured as a memory controller hub and peripheral controller hub within a system chipset that is in communication with processor(s) 1002.

Inference and/or training logic 715 are used to perform inferencing and/or training operations associated with one or more embodiments. In at least one embodiment portions or all of inference and/or training logic 715 may be incorporated into graphics processor(s) 1008. For example, in at least one embodiment, training and/or inferencing techniques described herein may use one or more of ALUs embodied in a graphics processor. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for network traffic monitoring and control.

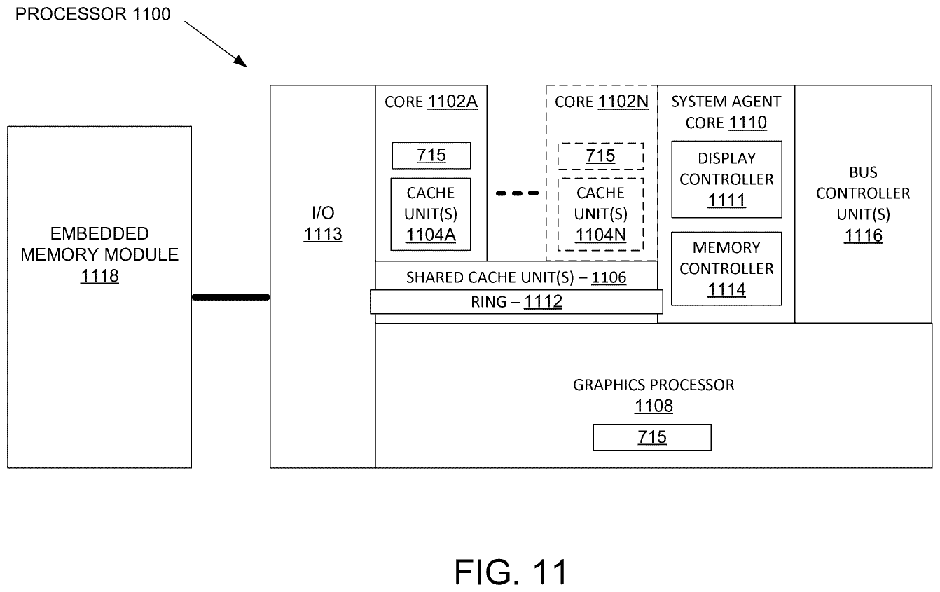

FIG. 11 is a block diagram of a processor 1100 having one or more processor core(s) 1102A-1102N, an integrated memory controller 1114, and an integrated graphics processor 1108, according to at least one embodiment. In at least one embodiment, processor 1100 can include additional cores up to and including additional core 1102N represented by dashed lined boxes. In at least one embodiment, each of processor core(s) 1102A-1102N includes one or more internal cache unit(s) 1104A-1104N. In at least one embodiment, each processor core also has access to one or more shared cached unit(s) 1106.

In at least one embodiment, internal cache unit(s) 1104A-1104N and shared cache unit(s) 1106 represent a cache memory hierarchy within processor 1100. In at least one embodiment, cache unit(s) 1104A-1104N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1106 and 1104A-1104N.

In at least one embodiment, processor 1100 may also include a set of one or more bus controller unit(s) 1116 and a system agent core 1110. In at least one embodiment, one or more bus controller unit(s) 1116 manage a set of peripheral buses, such as one or more PCI or PCI express busses. In at least one embodiment, system agent core 1110 provides management functionality for various processor components. In at least one embodiment, system agent core 1110 includes one or more integrated memory controllers 1114 to manage access to various external memory devices (not shown).

In at least one embodiment, one or more of processor core(s) 1102A-1102N include support for simultaneous multi-threading. In at least one embodiment, system agent core 1110 includes components for coordinating and operating processor core(s) 1102A-1102N during multi-threaded processing. In at least one embodiment, system agent core 1110 may additionally include a power control unit (PCU), which includes logic and components to regulate one or more power states of processor core(s) 1102A-1102N and graphics processor 1108.

In at least one embodiment, processor 1100 additionally includes graphics processor 1108 to execute graphics processing operations. In at least one embodiment, graphics processor 1108 couples with shared cache unit(s) 1106, and system agent core 1110, including one or more integrated memory controllers 1114. In at least one embodiment, system agent core 1110 also includes a display controller 1111 to drive graphics processor output to one or more coupled displays. In at least one embodiment, display controller 1111 may also be a separate module coupled with graphics processor 1108 via at least one interconnect, or may be integrated within graphics processor 1108.

In at least one embodiment, a ring based interconnect unit 1112 is used to couple internal components of processor 1100. In at least one embodiment, an alternative interconnect unit may be used, such as a point-to-point interconnect, a switched interconnect, or other techniques. In at least one embodiment, graphics processor 1108 couples with ring based interconnect unit 1112 via an I/O link 1113.

In at least one embodiment, I/O link 1113 represents at least one of multiple varieties of I/O interconnects, including an on package I/O interconnect which facilitates communication between various processor components and a high-performance embedded memory module 1118, such as an eDRAM module. In at least one embodiment, each of processor core(s) 1102A-1102N and graphics processor 1108 use embedded memory modules 1118 as a shared Last Level Cache.

In at least one embodiment, processor core(s) 1102A-1102N are homogenous cores executing a common instruction set architecture. In at least one embodiment, processor core(s) 1102A-1102N are heterogeneous in terms of instruction set architecture (ISA), where one or more of processor core(s) 1102A-1102N execute a common instruction set, while one or more other cores of processor core(s) 1102A-1102N executes a subset of a common instruction set or a different instruction set. In at least one embodiment, processor core(s) 1102A-1102N are heterogeneous in terms of microarchitecture, where one or more cores having a relatively higher power consumption couple with one or more power cores having a lower power consumption. In at least one embodiment, processor 1100 can be implemented on one or more chips or as an SoC integrated circuit.

Inference and/or training logic 715 are used to perform inferencing and/or training operations associated with one or more embodiments. In at least one embodiment portions or all of inference and/or training logic 715 may be incorporated into processor 1100. For example, in at least one embodiment, training and/or inferencing techniques described herein may use one or more of ALUs embodied in graphics processor 1108, processor core(s) 1102A-1102N, or other components in FIG. 11. In at least one embodiment, weight parameters may be stored in on-chip or off-chip memory and/or registers (shown or not shown) that configure ALUs of graphics processor 1100/1108 to perform one or more machine learning algorithms, neural network architectures, use cases, or training techniques described herein.

Such components can be used for network traffic monitoring and control.

Various embodiments can be described by the following clauses:

1. A processor comprising:
one or more processing circuits to:
   determine a change in a port state for a network connection;
   update one or more rules, associated with a datapath, for traffic associated with the network connection, based on the change; and
   cause the traffic to be transmitted based on the updated one or more rules.

2. The processor of clause 1, wherein the one or more processing circuits are further to:
clone the one or more rules, where the update to the one or more rules is applied to the cloned one or more rules.

3. The processor of clause 1 wherein the one or more processing circuits are further to:
determine the change in the port state is associated with a first port failure;
select a second port; and
cause a port selector to change a physical connection from the first port to the second port.

4. The processor of clause 3, wherein the one or more processing circuits are further to:
receive a confirmation the network connection associated with the second port is active.

5. The processor of clause 4, wherein the one or more rules are updated after the confirmation is received.

6. The processor of clause 1, wherein the one or more processing circuits are further to:
update a connection table associated with the datapath after the traffic is transmitted based on the updated one or more rules.

7. The processor of clause 1, wherein the one or more processing circuits are associated with a network resource or a network interface controller.

8. A network system, comprising:
a network interface controller (NIC) having two or more ports; and
a controller including one or more processing circuits, to:
determine a first status of a first port of the two or more ports has a threshold value;
establish a connection to a network using a second port of the two or more ports; and
update one or more rules for traffic associated with the NIC to transmit data using the second port.

9. The network system of clause 8, wherein the one or more rules are updated faster than a threshold period of time corresponding to a link breakup time for the network.

10. The network system of clause 8, wherein the controller is associated with firmware of the NIC.

11. The network system of clause 8, wherein the one or more processing circuits are further to:

receive confirmation that a second status of the second port of the two or more ports has a second threshold value.

12. The network system of clause 8, wherein the one or more processing circuits are further to:
select the second port based on one or more connection parameters.

13. The network system of clause 8, wherein the one or more processing circuits are further to:
select a third port of the two or more ports before the second port;
determine the connection to the network, using the third port, is unsuccessful; and
select the second port.

14. The network system of clause 8, wherein the one or more processing circuits are further to:
determine a subset of the one or more rules includes an identifier associated with the first port.

15. The network system of clause 8, wherein the one or more processing circuits are further to:
determine a priority for a first rule of the one or more rule associated with the traffic; and
responsive to the first status having the threshold value, assign a lower priority to the first rule.

16. A computer-implemented method, comprising:
determining a network connection to a target port is established;
identifying, within a software defined datapath, one or more rules associated with a prior port;
generating, for the software defined datapath, one or more updated rules replacing the prior port with the target port; and
causing transmission along the network connection according to the one or more updated rules.

17. The computer-implemented method of clause 16, wherein the generating the one or more updated rules is a firmware operation associated with a network interface controller.

18. The computer-implemented method of clause 16, further comprising:
deactivating the one or more rules; and
activating the one or more updated rules.

19. The computer-implemented method of clause 18, wherein the one or more updated rules are a cloned version of the one or more rules.

20. The computer-implemented method of clause 16, wherein the target port is selected by a port selector.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more processing circuits to:
determine a change in a port state for a network connection;
update one or more rules, associated with a datapath, for traffic associated with the network connection, based on the change; and
cause the traffic to be transmitted based on the updated one or more rules.

2. The processor of claim 1, wherein the one or more processing circuits are further to:
clone the one or more rules, where the update to the one or more rules is applied to the cloned one or more rules.

3. The processor of claim 1 wherein the one or more processing circuits are further to:
determine the change in the port state is associated with a first port failure;
select a second port; and
cause a port selector to change a physical connection from the first port to the second port.

4. The processor of claim 3, wherein the one or more processing circuits are further to:
receive a confirmation the network connection associated with the second port is active.

5. The processor of claim 4, wherein the one or more rules are updated after the confirmation is received.

6. The processor of claim 1, wherein the one or more processing circuits are further to:
update a connection table associated with the datapath after the traffic is transmitted based on the updated one or more rules.

7. The processor of claim 1, wherein the one or more processing circuits are associated with a network resource or a network interface controller.

8. A network system, comprising:
a network interface controller (NIC) having two or more ports; and
a controller including one or more processing circuits, to:
determine a first status of a first port of the two or more ports has a threshold value;
establish a connection to a network using a second port of the two or more ports; and
update one or more rules for traffic associated with the NIC to transmit data using the second port.

9. The network system of claim 8, wherein the one or more rules are updated faster than a threshold period of time corresponding to a link breakup time for the network.

10. The network system of claim 8, wherein the controller is associated with firmware of the NIC.

11. The network system of claim 8, wherein the one or more processing circuits are further to:
receive confirmation that a second status of the second port of the two or more ports has a second threshold value.

12. The network system of claim 8, wherein the one or more processing circuits are further to:
select the second port based on one or more connection parameters.

13. The network system of claim 8, wherein the one or more processing circuits are further to:
select a third port of the two or more ports before the second port;
determine the connection to the network, using the third port, is unsuccessful; and
select the second port.

14. The network system of claim 8, wherein the one or more processing circuits are further to:
determine a subset of the one or more rules includes an identifier associated with the first port.

15. The network system of claim 8, wherein the one or more processing circuits are further to:
determine a priority for a first rule of the one or more rule associated with the traffic; and
responsive to the first status having the threshold value, assign a lower priority to the first rule.

16. A computer-implemented method, comprising:
determining a network connection to a target port is established;
identifying, within a software defined datapath, one or more rules associated with a prior port;
generating, for the software defined datapath, one or more updated rules replacing the prior port with the target port; and
causing transmission along the network connection according to the one or more updated rules.

17. The computer-implemented method of claim 16, wherein the generating the one or more updated rules is a firmware operation associated with a network interface controller.

18. The computer-implemented method of claim 16, further comprising:
deactivating the one or more rules; and
activating the one or more updated rules.

19. The computer-implemented method of claim 18, wherein the one or more updated rules are a cloned version of the one or more rules.

20. The computer-implemented method of claim 16, wherein the target port is selected by a port selector.
